(19) United States
(12) Patent Application Publication
(10) Pub. No.: US 2023/0243426 A1
(43) Pub. Date: Aug. 3, 2023

(54) COMPOSITE GASKET WITH NON-METALLIC INSERT

(71) Applicant: VSP Tech., Inc., Prince George, VA (US)

(72) Inventors: Reid Moulton Meyer, Saint Simons Island, GA (US); Alfred Fitzgerald Waterland, III, Chesterfield, VA (US); Jeffery William Wilson, Colonial Heights, VA (US)

(73) Assignee: VSP Tech., Inc., Prince George, VA (US)

(21) Appl. No.: 18/157,349

(22) Filed: Jan. 20, 2023

Related U.S. Application Data
(60) Provisional application No. 63/304,192, filed on Jan. 28, 2022.

(51) Int. Cl. F16J 15/14

(52) U.S. Cl. CPC F16J 15/14

(57) ABSTRACT

A composite gasket formed of a fluoropolymer and having a non-metallic fluoropolymer insert can be used in many applications. The non-metallic insert is corrosion resistant and can be formed into many different shapes and sizes as dictated by the particular application desired.

### CROSS-REFERENCE TO RELATED APPLICATION

This application claims the benefit of U.S. Provisional Application No. 63/304,192, filed Jan. 28, 2022, the contents of which are incorporated herein by reference.

### FIELD OF THE INVENTION

The present invention relates generally to composite gaskets for use on Fiberglass Reinforce Plastic (FRP) flanges within the steel industry. More specifically, the invention relates to composite gaskets that use non-metallic inserts to reduce and prevent leaks on such flanges within a steel refinery.

### BACKGROUND OF THE INVENTION

Commercially available composite gaskets have been utilized on Fiberglass Reinforced Plastic (FRP) flanges in a steel refinery with only limited success. Such gaskets are typically formed of polytetrafluoroethylene (PTFE) gaskets that include encapsulated metallic inserts. They can be used in steel refineries whose processes are operated at 85° C. and hydrochloric acid (HCl) at a concentration of up to 30%. Given these conditions, in one such commercially available gasket, alloy C276 was selected for the insert metallurgy due to its heightened chemical resistance compared to 316SS. Roughly 500 of these gaskets were installed in January 2021, and by July 2021, a handful (approximately 3) started experiencing slight leaks (liquid droplets). The connections required continued attention, and ultimately, the gaskets in these sections were removed from service and replaced with new gaskets of the same construction.

The gaskets removed from service were evaluated to determine the causes of the failure. The results indicated that due to the limited available (low) bolt load/torque of the FRP flanges and the resultant low compressive stress applied to the gaskets, the expanded polytetrafluoroethylene (ePTFE) layers of the composite gaskets were not fully densified/compressed, allowing the C276 inserts to be chemically attacked. Through continued discussions with the site, they determined their HCl concentration is actually between 20%-25%, lower than the anticipated 30% concentration. While the exact concentration remains uncertain, it is believed that the understress at the 25% concentration caused the chemical attack. Unfortunately, the reduction in the HCl concentration also reduces the chemical compatibility with C276 and is not recommended for long term use, confirming that the inserts evaluated were chemically attacked, thus causing the leaks.

There is a limited quantity of metals with long term chemical compatibility with HCl at these concentrations and temperatures; those that are compatible are rare, exotic metals, including Tantalum and Zirconium. There is a need for better insert materials with a broad compatibility allowing for long term corrosion-free performance of composite gaskets assembled under lower compressive stresses. Where the ePTFE sheath may not be fully densified during flange assembly; this can be caused by improper flange assembly practices, not applying the correct bolt load, or, for the application detailed above, on FRP flanges where low bolt loads are common because of the fragility of the flanges. In these FRP applications, it is common to not fully densify the ePTFE sheath to minimize the potential for the process chemically permeating through the substructure of the ePTFE and reaching the insert. In situations like this, it is critical to ensure the insert material is compatible with the process to avoid chemical attack/degradation.

Composite gasket inserts have historically been formed of metal and are broadly available and in use. In contrast to existing metal inserts with their limitations noted above, select non-metallic materials can operate under these circumstances without issue and worry of chemical degradation. With this insight, it is clear that utilizing non-metallic inserts with broad chemical compatibility for composite gaskets in low stress/low torque aggressive chemical service applications such as described above is critical in ensuring mechanical joint integrity for flanged connections.

Composite gaskets/technology has been limited to utilizing corrugated or flat metal inserts which, in low gasket stress applications had to be chemically compatible with the process media of the application due to the possibility of permeation through the ePTFE. Due to the beneficial performance of composite gaskets otherwise in very common, low bolt load flanges/services with aggressive chemicals such as HCl, exotic metal alloys are increasingly required to ensure the inserts are not chemically attacked in these low gasket stress applications.

Additionally, the metal inserts in the current gasket technology do not thermally bond to the ePTFE layers during the manufacturing process, resulting in the inserts being suspended within the gasket. This limits the overall gasket cross-section that can be designed, which creates difficulties ensuring concentric centering of the inserts within the gasket itself, and potential installation issues/damage when the gaskets are forced between flanges during installation, as they can be split by the embedded, floating insert.

### SUMMARY OF THE INVENTION

The invention relates to various exemplary embodiments, including gaskets with non-metallic inserts. These and other features and advantages of the invention are described below with reference to the accompanying drawings.

The invention relates to a gasket that includes a unitary construction formed of a first fluoropolymer and an insert embedded within and fully encased by the unitary construction. The insert is formed of a second fluoropolymer, the second fluoropolymer being different from the first fluoropolymer in polymer type, density, or structure, or the second polymer including a filler material. The first fluoropolymer may be formed of PTFE, porous PTFE, expanded PTFE, filled PTFE, microcellular PTFE, or a mixture thereof. The second fluoropolymer may be PTFE. In one implementation, the first fluoropolymer is expanded PTFE and the second fluoropolymer is PTFE. The insert of the gasket has an inner diameter and an outer diameter and may have a non-uniform shape between the inner diameter and the outer diameter. The unitary construction has an annular, or a non-annular shape, such as rectangular, square, or triangular shape. In a particular implementation, the unitary construction is a compressible PTFE sheath and the insert is thermally bonded within the unitary construction.

The gasket according to the invention may include an insert formed of a first fluoropolymer and an outer layer formed of a second fluoropolymer. The outer layer encapsulates the insert, with the second fluoropolymer being different from the first fluoropolymer in polymer type, density, or structure, or the second polymer including a filler material. The insert is thermally bonded to the outer layer and may include a filler formed of glass, silica, barium sulfate, silicon carbide, or a mixture thereof. In some implementations, the insert has a non-uniform cross-section. In particular, the first fluoropolymer may be expanded PTFE and the second fluoropolymer is PTFE. The gasket according to the invention may have various shapes including an annular, rectangular, square, or triangular shape. In particular, the first fluoropolymer is PTFE, porous PTFE, expanded PTFE, filled PTFE, microcellular PTFE, or a mixture thereof.

### BRIEF DESCRIPTION OF THE DRAWINGS

FIG. 1 is an annular shaped gasket according to the present invention.

FIG. 2 is a cross-sectional view of the gasket as shown in FIG. 1.

FIG. 3 is a rectangular shaped gasket according to the present invention.

FIG. 4 is a cross-sectional view of the gasket as shown in FIG. 3.

FIG. 5 is a perspective view of the components of the present invention in a spaced relationship in order to illustrate the method of forming a hybrid gasket according to the present invention.

FIG. 6 shows various geometries for the insert for an annular shaped gasket according to the present invention.

FIG. 7 shows cross-sectional views of the inserts as shown in FIG. 6.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Before the present invention is described in further detail, it is to be understood that the invention is not limited to the particular embodiments described, and as such, may of course vary. It is also to be understood that the terminology used herein is for the purpose of describing particular embodiments only, and is not intended to be limiting, since the scope of the present invention will be limited only by the appended claims.

A number of materials are identified as suitable for various aspects of the invention. These materials are to be treated as exemplary and are not intended to limit the scope of the claims. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

The composite gaskets described herein focus on expanding the application/utility of composite gasket technology by incorporating mechanically, and chemically suitable shaped (flat, corrugated, etc.) non-metallic inserts, replacing the corrugated metal insert technology currently utilized in some commercially available gaskets.

Various non-metallic materials could be used as an insert in, for example, a restructured PTFE material. Restructured PTFE, also called filled PTFE, is made from 100% pure PTFE; however, during the manufacturing process, other materials (fillers) are added to the compound to provide additional structure and increase the mechanical properties of the finished product. These non-metallic materials can be machined or molded in various surface profiles, including with corrugations to act as a spring or a stress intensifier. Additionally, molded restructured PTFE materials have different mechanical properties which are advantageous for this composite gasket product/technology, as molding allows for design advantages that improve sealing performance of the insert substrate by affecting the geometry and multiple regions of density and with varying thicknesses. This improves stability and creep relaxation which is often a problem associated with virgin or restructured PTFE materials in standard sheet form according to ASTM F38 creep relaxation testing. Fillers can be used in the PTFE inserts as well. Fillers that are typically used include glass, silica, barium sulfate, and silicon carbide.

The insert should be different from the construction of the primary gasket material in order to provide the advantages resulting therefrom. The insert could be formed of a different polymer, it could have a different density or structure, it could have a filler. For example, the outer gasket material could be expanded PTFE, while the insert is higher density PTFE.

Non-metallic materials can be manufactured into many shapes which corrugated metal inserts cannot, thereby greatly expanding the potential shapes for the gaskets. For example, composite gaskets with corrugated or surface profiled non-metallic inserts could be manufactured as rectangular, square, triangular shapes, as well as many others, depending on the particular application. Again, this is not possible with metallic inserts, underscoring the need for a wider range of materials with a broader performance-affecting versatility.

If the non-metallic insert is PTFE-based, it has the advantageous ability to thermally bond to ePTFE outer layers in the gasket during the manufacturing process. If the correct non-metallic material is utilized, this insert can be as narrow as ⅛″ or can be much wider and extend to the OD of the finished product. This selection of very narrow or wide inserts cannot be achieved with the current metal insert technology.

Therefore, with a composite gasket with an encapsulated non-metallic insert, the user gets the following benefits over, for instance, a traditional gasket with a metal insert:

1) Given ePTFE is broadly compatible with most chemical processes, the entire gasket can be compatible with the process and there is no need to worry about the degree of gasket compression, chemical attack or corrosion. This permits a genuine “universal” gasket, which eliminates the current requirement to ensure appropriate, chemically compatible metallic inserts, and the sometimes uncertainty regarding whether there is adequate compressive stress on the gasket in different applications/flanges/assembly practices to close the initial porosity of the ePTFE to prevent permeation.

2) If the non-metallic material for the insert is PTFE based, during the manufacturing process, the outer layers of ePTFE of the gasket may thermally bond to the insert eliminating the insert floating, increasing it manufacturability, and forming a unitized and fully bonded gasket. Utilizing this composition allows the dimensions (cross-section, core thickness, overall height, etc.) to differ from metal inserts now allowing for insert encapsulation with fluoropolymer-based gaskets to be narrower than commercially available metal composite gaskets where centering of the insert is critical due to the narrow sealing areas on the flanges.

3) With multiple insert construction options (flat, corrugated (machined or molded), wishbone, multiple-concentric, etc.) for the embedded insert; giving the gasket designer the ability to tailor the sealing solution to the end user's specific process revolutionizing the load concentration factors of the finished product, thus, optimizing the degree and location of load concentration within the gasket.

4) The gasket with a non-metallic insert is now capable of operating at lower temperatures (to about −450° F.) as compared to current gaskets manufactured with metal (304 stainless steel, 316 stainless steel, etc.) inserts which are limited to about −330° F. This is very important in cryogenic services/applications, as current gasket construction is limited to lower temperature limit of the metallic inserts.

Implementation of the present invention can overcome a number of limiting applications with flat or corrugated, metal insert composite gaskets. Narrow flange sealing surfaces require a precisely located insert within the body/cross-section of a gasket. Use of a PTFE based insert that is thermally bonded to the ePTFE and “locked” in place inside the gasket allows for narrower gasket cross sections than can currently be manufactured with a metallic insert that is floating inside the gasket, as allowance must be made for the ePTFE containment of the insert at both the ID and OD of the gasket. Generally, about ⅜ inch width of ePTFE is required at both the ID and OD to secure the loose metallic insert. This is especially important in semi-conductor and food/pharma applications/equipment and equipment flanges with narrow sealing areas.

PTFE based inserts for gaskets can be made with the insert OD extending all of the way to the gasket OD. Thermally bonded, there is no need for adhesive or any foreign substance to keep the gasket “unitized”. Designing the gasket with the insert extending to the gasket OD allows for narrower gasket cross sections, and a stiff, rugged gasket OD that will not deform when lodged in between two flanges. This high purity, 100% PTFE construction is necessary for semi-conductor, and food/pharma applications.

The non-metallic inserts eliminate the need for exotic alloy, metallic inserts. Under low compressive loads caused either by poor flange design or improper flange assembly, the ePTFE is not fully densified/compressed, and allows certain chemicals to permeate or “wick” through the ePTFE. In these applications the insert must be chemically compatible with the process. Currently, there are no satisfactory commercial gasket products that provide reliable, long-term sealing of certain temperature and concentrations for HCl acid in FRP/plastic flanges, as rare and expensive metal inserts are required. The cost of these rare and expensive inserts is economically unfeasible. Additionally, there is no absolute means of confirming that there will be adequate compressive stress applied to every metal-insert gasket in many other chemical services and flange designs, and thus whether a chemically compatible metallic insert is required for long term performance.

Furthermore, Use of non-metallic inserts allow for more precise design of the insert in low bolt load flange applications.

A composite gasket with a PTFE based insert can feature a completely bonded construction, as the ePTFE outer layers of the gasket are thermally bonded to the PTFE based insert during the manufacturing process. This gasket is fused together with heat and controlled light/optimum pressure, eliminating the need to use adhesives on any component of the gasket. Since this gasket is fully fused together and manufactured from sheet materials, the finished gaskets thickness (0.093 in-0.250 in), dimensions (inner and outer diameter), and geometries (annular rings, squares/rectangles, ovals, obrounds, etc.) can be 100% customizable to meet the needs of user's applications.

The outer layers of the gasket could be made from micro-cellular or expanded PTFE. Expanded PTFE utilizes a proprietary manufacturing process to create biaxial-oriented (stretched both horizontally and vertically (x and y axis)) gaskets (or sheets) forming a matrix of aid voids and ePTFE fibrils. These air voids and fibers/fibrils are formed during the stretching process and create a more compressible material (because of the air voids) with significantly reduced creep/cold flow (material flowing outward) because of the high tensile strength ePTFE fibers/fibrils. The air voids make the outer layers of the gasket more compressible, allowing the gasket to easily deform/adapt to flange surface imperfections, which is ideal for sealing bolted flanged connections. This high compressibility/adaptability allows the gasket to provide a tighter (lower leakage) connection.

The embedded insert may be made from non-metallic materials, can be either extremely rigid or exhibit varying degrees of malleability providing a range of exceptional mechanical performance in high, medium or low gasket stress applications across a wide temperature range (about −450° F. to 600° F.), which can be selected/designed to exhibit minimal gasket creep/cold flow, differing degrees of material stability and mechanical properties, and varying degrees of gasket compression and stress/leakage performance of the resultant gasket.

If the insert material utilized is PTFE-based, these materials have similar temperature characteristics, they bond together during the bonding/fusing process creating a one-piece design. It is important to keep within the temperature limitations, so we do not damage any aspect of the gasket.

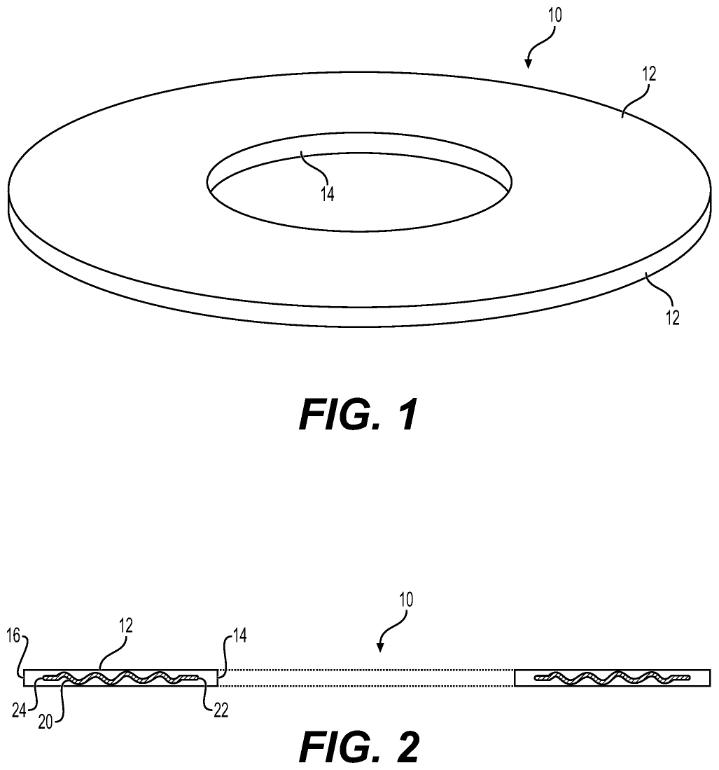

Turning now to the figures, FIGS. 1-6 show various implementations of the present invention. FIG. 1 shows a fluoropolymer based gasket 10 having a generally unitary polymer body construction 12 and having an inner diameter 14 and an outer diameter 16. In preferred embodiments, the fluoropolymer is PTFE-based (expanded, virgin, filled/reprocessed), but additional fluoropolymers, graphite/carbon-based and vulcanized elastomers may be used with the present invention. Examples of such materials include virgin and modified PTFE (TFM, PTFE), perfluoroylalkoxy alkanes (PFA), fluorinated ethylene propylene (FEP), fluoroelastomers or fluorocarbons (FKM, Viton™ elastomer), tetrafluoroethylene/propylene (Aflas® elastomer), and others. In general, expanded or filled polymers that may compress may be used according to the invention, including blends of two or more such polymers.

FIG. 2 shows a cross-section of gasket 10 that includes an insert 20. Insert 20 can be various non-metallic materials depending on the chemical service/concentration application of gasket 10. In a preferred embodiment, insert 20 is filled PTFE, but can include other non-metallic insert materials, such as elastomers, thermoplastics, sPVC, compressed non-asbestos composites, and others. The gaskets 10 of the present invention could be formed and manufactured according to the process set out in U.S. Pat. No. 8,066,843, the contents of which is incorporated herein by reference.

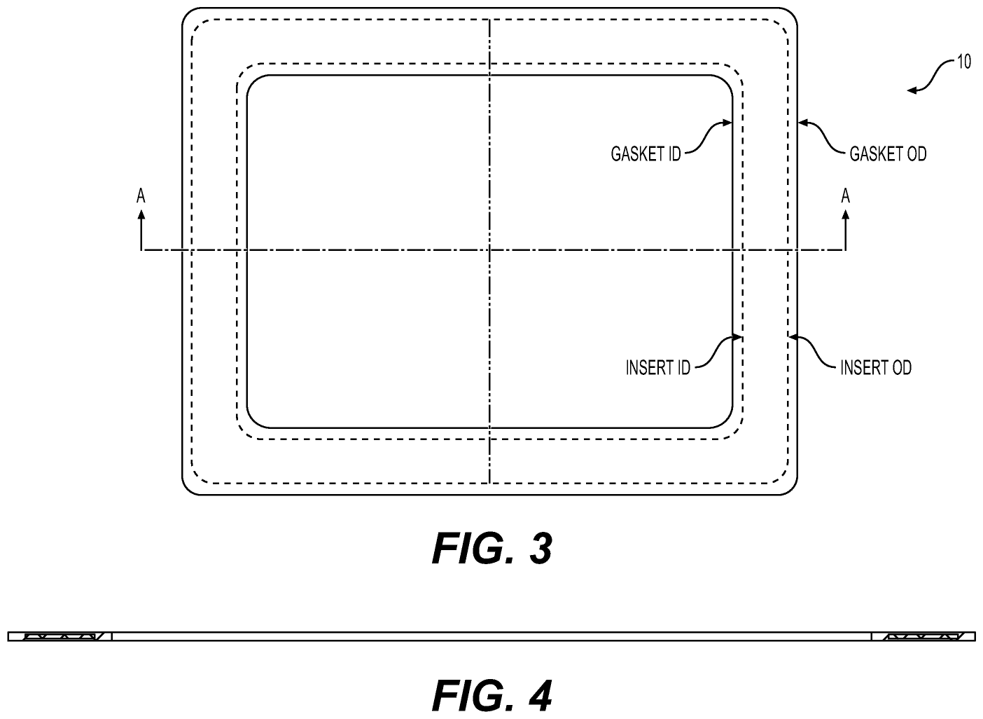

FIG. 3 shows gasket 10 having a rectangular shape. FIG. 4 shows gasket 10 in cross-section, thereby showing insert 20 with a similar rectangular shape. As noted above, an advantage of non-metallic inserts is the ease of forming them inserts into any shape desired by the particular gasket application; a characteristic that is not broadly possible with metallic inserts.

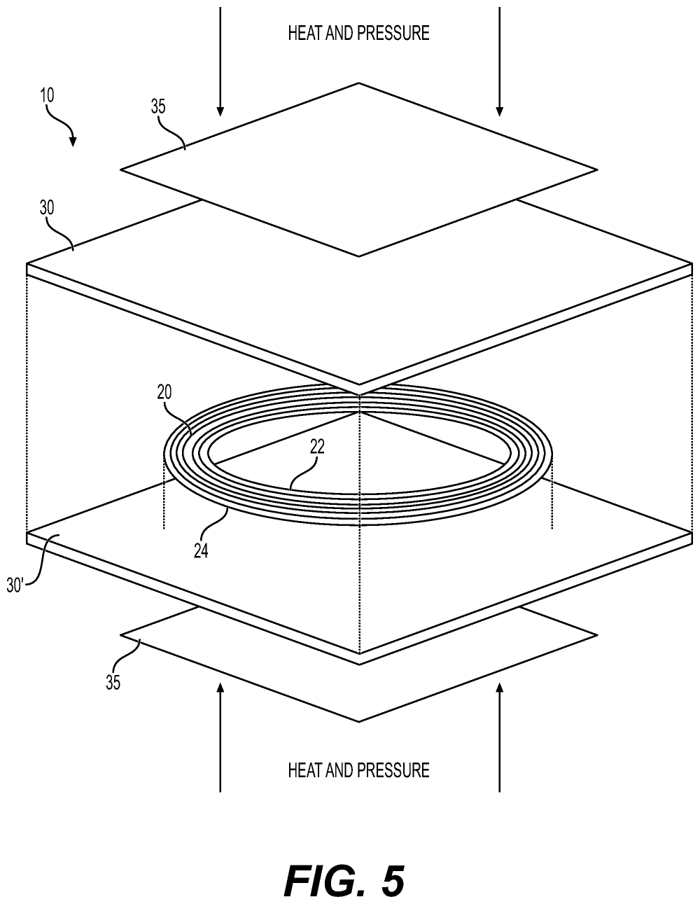

In more detail, and as illustrated in FIG. 5, seamless hybrid gasket 10 is formed from at least two initial sheets of polymer 30, 30′ that are then unified to form a unitary (homogeneous) polymer construction 12, completely encapsulating the insert 20. The polymer sheets can be any shape that covers insert 20 in a manner to allow contact between the sheets 30, 30′ along portions of the polymer inside the entirety of insert ID 22 and outside the insert OD 24. Heat and pressure can then be applied to one or both sheets 30, 30′ to unify them.

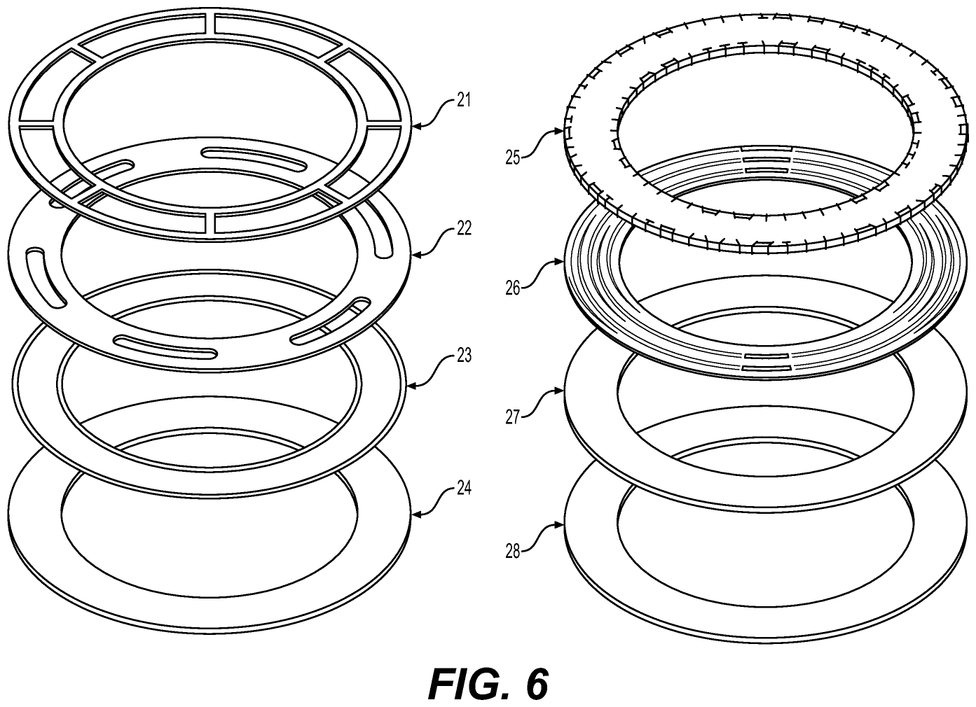

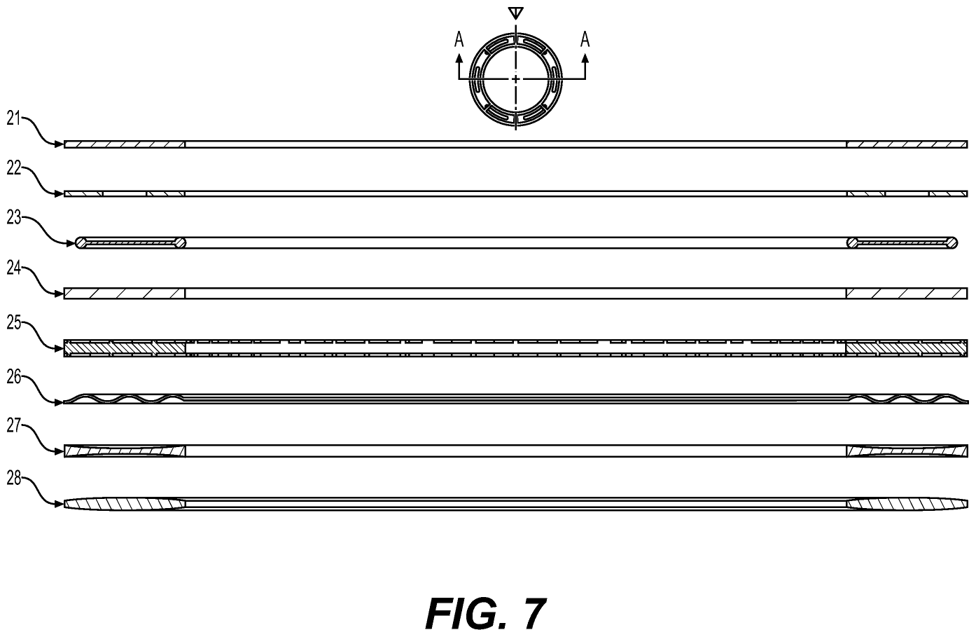

As noted above, an advantage of a non-metallic insert 20 is the ability to form inserts 20 of various shapes, thus permitting gaskets 10 to be formed of various shapes as dictated by the particular application. FIGS. 6-7 show inserts 20 of differing shapes and sizes, including inserts having reduced surface area 21, 22; a dog bone style 23 where the insert ID and OD are raised or thicker while the insert is flatter between them; an insert with a flat profile 24; an insert with a raised profile 25, a corrugated profile 26, a concave insert 27, and a convex insert 28. Cross-sectional views of these inserts are shown in FIG. 7 taken along, for example line A-A. As should be amply demonstrated from these examples, inserts can be formed of any custom shape and cross-section and is only limited by the application of the use of the gasket.

### EXAMPLE

A specific composite gasket, namely gaskets made with non-metallic inserts, were evaluated using the EN13555 leakage standard at 10 bar internal pressure, and their results were compared to a PITA® gasket made with a metal insert. For reference, the sealing performance was also compared to expanded PTFE sheet gaskets with no inserts. While the non-metallic insert gasket results were not an exact match to those of a PITA® gasket with a metal insert, they pass the leakage standard for use per the current revision of the TA Luft leakage standard. This requires the leak rate to be at or below 1E−3 mg/s/m at 4,350 psi gasket stress. However, the steel refinery's leakage requirements are governed by the leak rate detailed in a previous version of the TA Luft leakage standard; leak rate to be at or below 1E−1 mg/s/m at 4,350 psi gasket stress. All of the gaskets with non-metallic inserts meet the steel refinery leakage requirement and pass the current revision of the TA Luft standard; the only exception is the corrugated SiC Filled PTFE at ambient temperature. As can be seen, the expanded PTFE gasket without an insert requires the highest stress to achieve the required level of leakage and does not meet the stress/leakage requirements. This is one of the reasons that expanded PTFE gaskets with a suitable metallic or non-metallic insert are required. The results of the tests are shown graphically below.

While the leak rate for the PTFE inserts was slightly higher than for the metal inserts, the results are within an acceptable range. Given the vast advantages of the non-metallic inserts that have been demonstrated throughout this disclosure—including chemical compatibility, the ability to use many different shapes for both the inserts and the gaskets, and others—the slightly higher leak rate is not a drawback over the gaskets with the metallic inserts.

Numeric values and ranges are provided for various aspects of the implementations described above. These values and ranges are to be treated as examples only and are not intended to limit the scope of the claims.

While the invention has been described in conjunction with specific exemplary implementations, it is evident to those skilled in the art that many alternatives, modifications, and variations will be apparent in light of the foregoing description. Accordingly, the invention is intended to embrace all such alternatives, modifications, and variations that fall within the scope and spirit of the appended claims.

What is claimed is:

1. A gasket comprising:
a unitary construction formed of a first fluoropolymer; and
an insert embedded within and fully encased by the unitary construction, the insert formed of a second fluoropolymer, the second fluoropolymer being different from the first fluoropolymer in polymer type, density, or structure, or the second polymer including a filler material.

2. The gasket of claim 1, wherein the first fluoropolymer is PTFE, porous PTFE, expanded PTFE, filled PTFE, microcellular PTFE, or a mixture thereof.

3. The gasket of claim 1, wherein the second fluoropolymer is PTFE.

4. The gasket of claim 1, wherein the first fluoropolymer is expanded PTFE and the second fluoropolymer is PTFE.

5. The gasket of claim 1, wherein the insert has an inner diameter and an outer diameter and a non-uniform shape between the inner diameter and the outer diameter.

6. The gasket of claim 1, wherein the unitary construction has an annular, rectangular, square, or triangular shape.

7. The gasket of claim 1, wherein the unitary constructure has a non-annular shape.

8. The gasket of claim 1, wherein the unitary construction is a compressible PTFE sheath and the insert is thermally bonded within the unitary construction.

9. A gasket comprising:
an insert formed of a first fluoropolymer;
an outer layer formed of a second fluoropolymer, the outer layer encapsulates the insert, wherein the second fluoropolymer being different from the first fluoropolymer in polymer type, density, or structure, or the second polymer including a filler material.

10. The gasket of claim 9, wherein the insert is thermally bonded to the outer layer.

11. The gasket of claim 9, wherein the insert includes a filler formed of glass, silica, barium sulfate, silicon carbide, or a mixture thereof.

12. The gasket of claim 9, wherein the insert has a non-uniform cross-section.

13. The gasket of claim 9, wherein the first fluoropolymer is expanded PTFE and the second fluoropolymer is PTFE.

14. The gasket of claim 9, wherein the gasket has an annular, rectangular, square, or triangular shape.

15. The gasket of claim 9, wherein the first fluoropolymer is PTFE, porous PTFE, expanded PTFE, filled PTFE, microcellular PTFE, or a mixture thereof.
